(19) United States
(12) Patent Application Publication
(10) Pub. No.: US 2010/0266733 A1
(43) Pub. Date: Oct. 21, 2010

(54) PIZZA AND TRAY COMBINATION AND METHODS

(75) Inventors: David Charles Rettey, Tracy, MN (US); Wayne Michael Pafko, Marshall, MN (US); Joey J. Hasse, Marshall, MN (US); Jim A. McGillivray, Lynd, MN (US); Robert B. Shomo, JR., Balaton, MN (US); Michelle Ruth Walter, Cincinnati, OH (US)

Correspondence Address: MERCHANT & GOULD PC, P.O. BOX 2903, MINNEAPOLIS, MN, 55402-0903, US

(73) Assignee: SCHWAN'S SALES ENTERPRISES, INC., Marshall, MN (US)

(21) Appl. No.: 12/767,381

(22) Filed: Apr. 26, 2010

Related U.S. Application Data
(63) Continuation of application No. 11/831,609, filed on Jul. 31, 2007.

(51) Int. Cl. B65D 81/34; A21D 10/02; A23L 1/01

(52) U.S. Cl. 426/113; 426/394; 426/556

(57) ABSTRACT

A frozen pizza and tray combination and related methods are disclosed. The combination includes a bakeable single-use disposable tray having a holding surface and a frozen pizza. The holding surface has a substantially flat cooking side and an opposite oven-engaging side. The frozen pizza includes a crust and toppings. The crust has a bottom surface positioned on and against the cooking side of the flat holding surface of the bakeable tray. The frozen pizza also includes a cut arrangement extending through a thickness of the crust and includes a cut line having uncut portions of the crust along the cut line. One method of the disclosure includes slicing the pizza with at least one cut line into individual pieces and leaving uncut portions along the cut line such that no individual piece is disconnected from a remaining portion. The sliced pizza can then be placed into a tray and frozen.

### CROSS-REFERENCE TO RELATED APPLICATIONS

This application is a continuation of U.S. application Ser. No. 11/831,609, filed Jul. 31, 2007, which application is incorporated herein by reference.

### TECHNICAL FIELD

This disclosure relates to a pizza delivery system, including a frozen pizza crust and a bakeable tray and methods of making and using.

### BACKGROUND

Delivered pizza is pre-cut into individual serving pieces, and is delivered in a disposable box. Thus, with delivered pizza, no tools are required to cut the pizza, and no dishes are needed for holding the pizza. The box may be disposed of, and there are no additional serving trays that must be washed and put away. With typical frozen pizzas, the pizza must be transferred to a tray, either for cooking or for serving. In addition, the frozen pizza, after cooking, must then be cut using a pizza cutter or other cutting instruments. The tray and the cutter must then be washed.

The inventors have recognized that it would be desirable to have a frozen pizza that had the convenience of delivery pizza.

### SUMMARY OF THE DISCLOSURE

The present disclosure is directed to a frozen pizza and tray combination and methods that substantially obviate one or more of the problems due to the limitations and disadvantages of the prior art. Among other advantages, a system is provided including a frozen pizza in which no tools are needed to cut the pizza into individual serving pieces and which the tray is disposable.

To achieve the advantages and in accordance with the purposes of the general principles of this disclosure, as embodied and broadly described herein, a frozen pizza and tray combination is provided. The combination includes a bakeable single-use disposable tray including a holding surface. The holding surface has a substantially flat cooking side and an opposite oven-engaging side. The combination further includes a frozen pizza including a crust and toppings on the crust. The crust has a bottom surface positioned on and against the cooking side of the holding surface of the bakeable tray. The frozen pizza further includes a cut arrangement extending through a thickness of the crust. The cut arrangement includes a cut line having uncut portions of the crust along the cut line.

In preferred arrangements, the cut arrangement includes at least one cut line extending through the thickness of the crust and dividing the frozen pizza into individual serving pieces. The at least one cut line has uncut portions along the cut line such that no individual serving piece is disconnected from a remaining portion of the pizza.

In preferred embodiments, the cut lines are water-jet formed cut lines, ultrasonic formed cut lines, or blade formed cut lines.

In preferred embodiments, the pizza is round (circular), and the individual serving pieces formed by the at least one cut line includes at least two sectors of the circular pizza. Between adjacent ones of the sectors are uncut portions. In some embodiments, there are a plurality of cut lines and at least 6 sectors.

Preferably, each of the uncut portions has a length no greater than one inch.

Preferably, the bakeable single-use disposable tray comprises paperboard, CPET, aluminum, corrugate or others.

In another aspect, a method of making a combination frozen pizza and bakeable tray is provided. The method includes providing an uncooked and unfrozen pizza including a crust with toppings. Next, the method includes slicing the pizza with cut lines into individual serving pieces and leave uncut portions along the cut line such that no individual serving piece is disconnected from a remaining portion of the pizza. Next, the method includes placing the sliced pizza into a bakeable single-use disposable tray such that a bottom of the crust is oriented against a substantially flat cooking surface on the bakeable single-use disposable tray to form a sliced pizza and tray arrangement. Next, the method includes freezing the sliced pizza and tray arrangement.

Preferably, the step of providing an uncooked and unfrozen pizza includes providing a circular pizza, and the step of slicing the pizza includes slicing the pizza into at least six sectors and leaving uncut portions along the cut lines. Each uncut portion has a length no greater than one inch.

In another aspect, a method of making a pizza is provided. The method includes providing a frozen pizza and tray combination including a bakeable single-use disposable tray including a holding surface with a substantially flat cooking side and an opposite oven-engaging side; a frozen pizza including a crust and toppings on the crust; the crust having a bottom surface positioned on and against the cooking side of the holding surface of the bakeable tray; the frozen pizza including a cut arrangement extending through a thickness of the crust; and the cut arrangement including a cut line having uncut portions of the crust along the cut line. Next, the method includes putting the frozen pizza and tray combination into an oven. Next, there is the step of baking the frozen pizza and tray combination to result in a cooked pizza on the tray. Next, there is the step of removing the tray holding the cooked pizza from the oven. Next, the method includes dividing the cooked pizza into individual serving pieces by manually and without a use of a cutter, breaking the uncut portions of the crust. Next, the method includes disposing of the tray.

Preferably, the step of dividing includes pulling by hand an individual serving piece away from a remaining portion of the pizza and breaking at least one uncut portion; the uncut portion having a length of not greater than one inch.

It is to be understood that both the foregoing general description and the following detailed description are exemplary and explanatory only. The accompanying drawings, together with the description, serve to explain the principles of this disclosure.

### BRIEF DESCRIPTION OF THE DRAWINGS

FIG. 1 is a top plan view of a frozen pizza and tray combination, constructed according to principles of this disclosure;

FIG. 2 is a perspective view of the tray utilized in the combination illustrated in FIG. 1;

FIG. 3 is a top plan view of the tray illustrated in FIG. 2;

FIG. 4 is a cross-sectional view of the tray depicted in FIG. 3, the cross-section being taken along the line 4-4 of FIG. 3; and

FIG. 5 is a perspective view of a portion of the frozen pizza of FIG. 1, outside of the tray.

### DETAILED DESCRIPTION

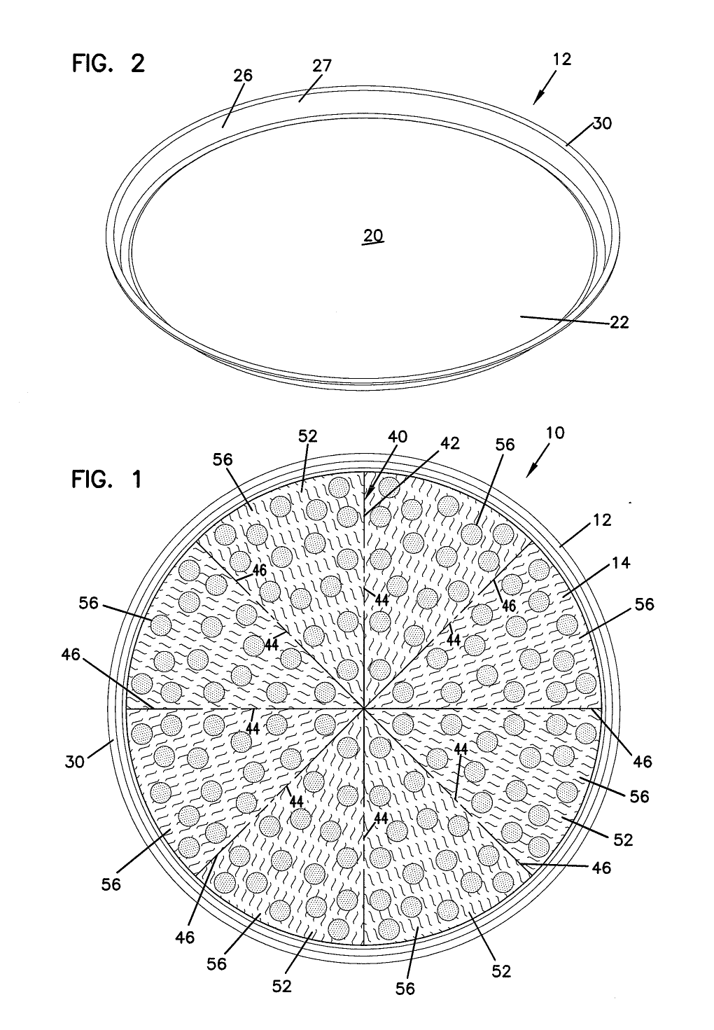

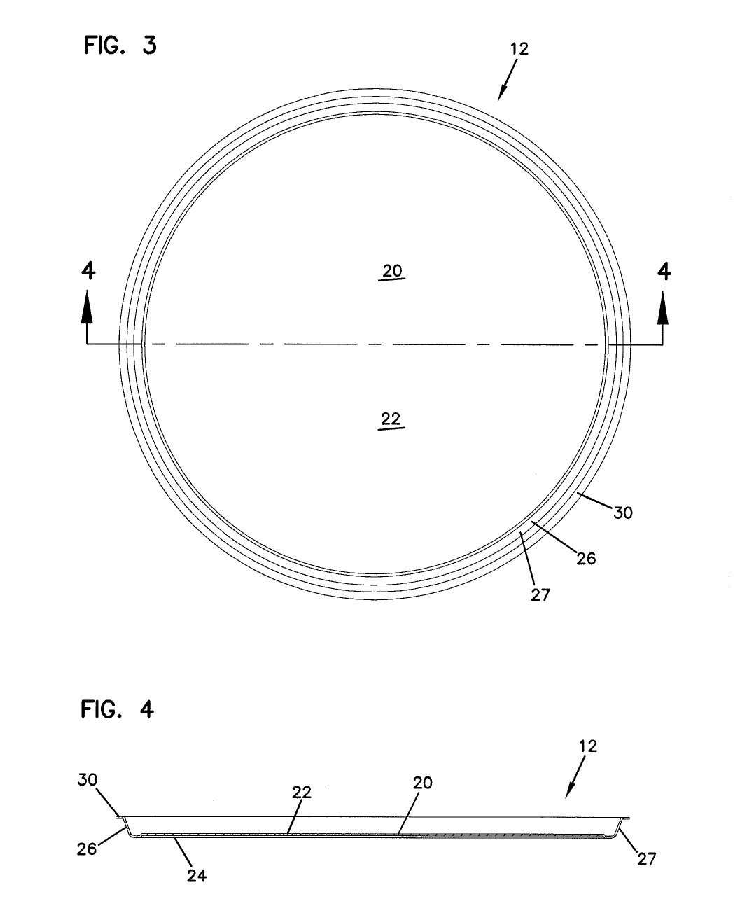

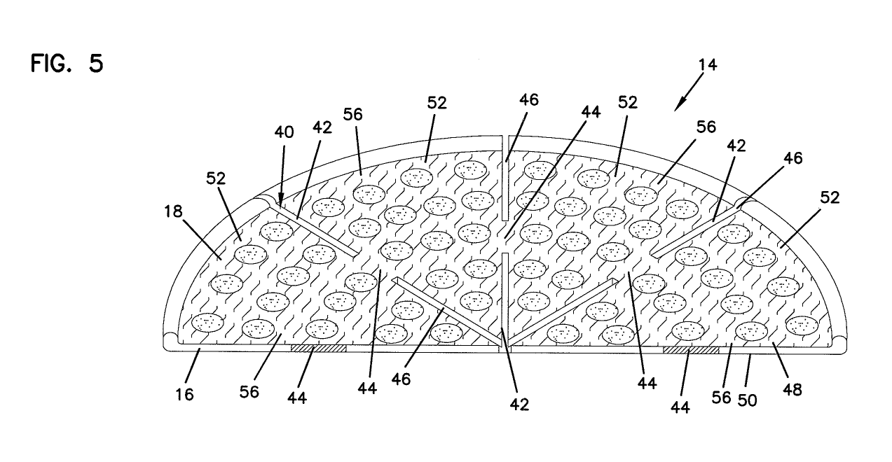

In FIG. 1, a pizza and tray combination is illustrated at reference numeral 10. The combination includes a bakeable tray 12 (see also FIGS. 2-4) that is designed to hold and provide a cooking instrument for a frozen pizza 14. In FIG. 5, it can be seen that the frozen pizza 14 includes a crust 16 and toppings 18. The toppings 18 can be any one of or several of the following: sauces, cheese, meats, vegetables, fruits, spices, condiments, fats such as butter or oil, and other miscellaneous toppings that may be desirable for consumption. The pizza 14 is frozen such that it, along with the tray 12, may be directly moved from a freezer into an oven for cooking.

Preferably, the tray 12 is constructed of a material that allows it to be easily disposable. One such material is paperboard. Other useable materials include crystalline polyethylene terephthalate (CPET), aluminum such as aluminum foil, corrugate, or others. A bakeable single-use disposable tray allows the tray 12 to be heated in an oven, provide a cooking instrument for the pizza 14, and then be disposed of after the pizza is removed from the tray 12. One example usable material is a pressed paperboard tray constructed of solid bleached sulfate of about 268-329 lbs/3000 sq. ft. For example, a paperboard tray of a solid bleached sulfate construction and being able to sustain about 295-305 lbs/3000 sq. ft. is usable.

The tray 12 includes a holding surface 20. The flat holding surface has a substantially flat cooking side 22 and an opposite oven-engaging side 24. By the term “substantially flat”, it is meant to distinguish bowl-shaped or curved shaped cooking sides, but does allow for small changes (unflat) shapes in the surfaces for embossments or embossments or general material irregularities. The cooking side 22 functions to interact with the crust 16 of the pizza 14 and provide a cooking surface for the pizza 14. In implementation, one usable material for the cooking side 22 is polybutylene terephthalate (PBT) polyester. The cooking side 22 is preferably flat without curves, arcs, or bends, but as mentioned above, does allow for embossments, small minor unflat surface changes, and general material irregularities. It has been found that a flat (including substantially flat) cooking side 22 results in desirable properties for the baked crust 16. The oven-engaging side 24 is also preferably substantially flat in some embodiments.

In the embodiment shown in FIGS. 2-4, the tray 12 further includes a side panel 26. The side panel 26 extends vertically from the holding surface 20 to form a perimeter side panel or border 27. The tray 12 may have a variety of shapes. The tray 12 can be rectangular, square, irregular, round, etc. In the particular embodiment illustrated in FIGS. 1-4, the tray 12 is round or circular. The tray will be a size that is a size small enough to fit within a normal, consumer-size oven. For example, usable sizes include an overall length of 4-20 inches. If round, this length would be a diameter of 4-20 inches. A useful perimeter side panel 26 will extend 0.25-1.0 inch from the holding surface 20. In preferred implementations, the side panel 26 will have a taper such that it will be angled away from the cooking surface 22 at about 13-23 degrees off of a vertical line, for example, about 17-19 degrees off of a vertical line. A useful overall dimension, such as a diameter, of the tray 12 would be 5-18 inches, with a perimeter side panel 26 extending 0.25-0.75 inch. The tray 12 can also have a flange 30 extending from the side panel 26. The flange 30 can have a length of 0.12-0.25 inch, for example, 0.18-0.19 inch. When there is a side panel 26, such as in the example shown in the drawings, the tray 12 will have a depth measured from the top of the side panel 26 (corresponding to the flange 30) to the top of the cooking side 22 of about 0.4-0.6 inch, for example, about 0.5 inch.

Turning again to FIG. 1 and FIG. 5, the pizza 14 includes, in the embodiment shown, a cut arrangement 40 extending through a thickness of the crust 16. The cut arrangement 40 includes a cut line 42 having uncut portions 44 of the crust 16 along the cut line 42. The cut arrangement 40 can be in a variety of implementations. For example, the cut arrangement 40 can cut the pizza 14 into various geometric patterns or shapes. The cut arrangement 40 can be at least one cut line, including a single cut line 42 or can include, as shown in the embodiment of FIG. 1, a plurality of cut lines 46. Each of the cut lines 46 extends through the thickness of the crust 16 from a top 48 of the pizza 14 all the way through to a bottom 50 of the pizza 14. In the embodiment shown in FIG. 1, the cut lines 46 divide the pizza 14 into individual serving pieces 52.

Still in reference to FIG. 1, the cut lines 46 include uncut portions 44 along the cut lines 46 such that no individual serving piece 52 is disconnected from a remaining portion of the pizza 14. The cut arrangement 40 is in place, such that, in the embodiment of FIG. 1, the entire frozen pizza 14 can be moved around, transferred, and placed in the tray 12 in a single piece without the individual pieces 52 becoming separated from the remaining portion of the frozen pizza 14. This is convenient for manufacturing purposes, for example.

Preferably, the cut lines 46 are formed by a water-jet process, so that the cut lines 46 are water-jet formed cut lines. One usable water-jet formed cut line will be made by using a water jet that uses a 0.009 inch orifice. It should be understood that while using a water-jet cutter to result in water-jet formed cut lines is one usable method, other methods can be used to achieve cut lines, including ultrasonics to result in ultrasonic formed cut lines, or knives or blades to result in blade formed cut lines

In the embodiment of FIG. 1, the frozen pizza 14 is circular, and the cut lines 46 form individual serving pieces 52 cut into at least six sectors 56 of the pizza 14. In the particular embodiment shown, the pizza 14 is cut into eight sectors 56. In one embodiment, the pizza 14 includes a single cut line 46, cutting the pizza 14 into two sectors 56. As such, the cut line 46 divides the pizza 14 into at least two sectors 56, and it should be understood that the cut line 46 can divide the pizza 14 into more than eight sectors 56, such as up to 30 sectors.

Between adjacent ones of the sectors 56 are the uncut portions 44. While sectors 56 are illustrated, and as mentioned above, it should be understood that the pieces 52 can be cut into a variety of patterns including rectangular, square, irregular, triangle, etc. Each of the uncut portions 44 has a length that is sufficiently long to hold the individual pieces 52 together with a remaining portion of the pizza, but small enough to allow for it to be easily separated without the use of tools, from a remaining portion of the pizza after baking by the consumer. For example, it is convenient if each of the uncut portions has a length no greater than 1 inch. It is convenient if each of the uncut portions has a length of ⅛^{th}-¾^{th} inch.

In the embodiment shown, there is a single uncut portion 44 between each adjacent sector 56. In other implementations, there can be more uncut portions 44 between adjacent individual pieces 52. For example, a perforated cut line could be used in which a plurality of cut portions alternately trade off with uncut portions in series.

Certain dough formulations have been found usable with the tray 12 to result in a crust that good performance with the tray 12. For example, a dough formulation having the following has been found useful, with percentages given being percentage of weight: flour, spring hard 55-65%; water, 25-30%; salt, granulated 1-3%; sugar, granulated, 1-3%; yeast, cream, 3-8%; shortening, palm flakes, 1-4%; dough conditioner, 1-2%. Further ingredients can include bread crumbs and garlic butter oil. For pizzas having an 11 inch crust, the weight of the dough plus the bread crumbs and garlic butter oil will be about 11-12 ounces. For a pizza having a crust of about 13 inches, the weight of the dough plus the bread crumbs and garlic butter oil will be about 16-17 ounces.

One useful dough formulation includes the following, with percentage given being percent of weight: flour, spring hard 59-60%; water, 28-29%; salt, granulated 1-2%; sugar, granulated, 1-2%; yeast, cream, 5-6%; shortening, palm flakes, 2-3%; dough conditioner, 1-2%. For an 11 inch diameter crust, about 0.4-0.6 oz. bread crumbs, and 0.15-0.25 oz. garlic butter oil. For a 13 inch diameter crust, about 0.65-0.75 oz. bread crumbs and about 0.3 oz. garlic butter oil.

A method of making a combination frozen pizza and bakeable tray is provided. The method includes providing an uncooked and unfrozen pizza. The pizza would include a crust with toppings. Next, a cutter (such as a water jet, or ultrasonics, or a blade) slices the pizza to form cut lines 46 into individual pieces 52 and leave uncut portions 44 along the cut line 46 such that no individual serving piece 52 is disconnected from a remaining portion of the pizza. Next, the sliced pizza is placed onto the bakeable tray 12, such that the bottom 50 is oriented against the flat cooking surface 22 on the bakeable tray 12 to form a sliced pizza and tray arrangement. The step of placing the sliced pizza onto the tray is convenient since the uncut portions 44 hold the entire pizza together, so that no individual pieces are separated from a remaining portion of the pizza. Next, the sliced pizza and tray arrangement is frozen. The frozen sliced pizza and tray arrangement can be packaged into packaging materials for sales to a consumer before or after freezing.

The step of slicing includes, if the pizza is circular, slicing the pizza into at least two sectors and leaving uncut portions 44 along the cut lines 46, with each uncut portion having a length no greater than one inch. The method of slicing can also include slicing the pizza into a variety of other shaped individual pieces or into a variety of other shapes.

A method of making a pizza includes putting the frozen pizza and tray combination 10 into an oven. Next, the frozen pizza and tray combination 10 is baked for a suitable amount of time to result in a cooked pizza on the tray. For example, the frozen pizza can be baked at an oven of 350-500 degrees for 10-20 minutes. Next, the tray holding the cooked pizza is removed from the oven. Next, the cooked pizza is divided into individual serving pieces by manually, and without the use of a cutter, breaking the uncut portions 44 of the crust 16. After the pizza has been consumed or otherwise disposed of or stored for later consumption, the tray 12 is disposed of, such as in the garbage or recycled. The tray 12 is made of a material that can be incinerated as well. The tray 12 is not reused.

The step of dividing the pizza includes pulling by hand an individual serving piece 52 away from a remaining portion of the pizza 14 and breaking at least one uncut portion 44. The uncut portion 44 will have a length of not greater than one inch. It should be understood that the use of a cutter is not needed. If, for some reason, the consumer would like to use a pizza cutter, it is certainly possible for the consumer to use a cutting device on the uncut portions 44.

### Experimental Results

The crust 16 has been formulated and selected to perform with the paperboard baking tray 12 to result in surprisingly good properties. Just any pizza crust will not give high quality, desirable properties.

Research was conducted among past 6 month super-premium frozen pizza users. Respondents also must have been past 6 month purchasers of delivery pizza in the “Delivered Pizza” cells. Specific respondent qualifications included:
Age 21-54
Primary/Shared Grocery Shopper
HH Income of $50,000 or more
Past 6-month purchaser of super-premium frozen pizza (for example, Freschetta, DiGiorno, CPK, Wolfgang Puck)
In the “Delivered Pizza” cells, past 6-month purchasers of delivery pizza (for example, Pizza Hut)
Open to Pepperoni variety
No food allergies

Test results for the crust evaluation of the claimed frozen pizza having the dough recipe provided above and bakeable single-use disposable tray combination, in this case, a paperboard tray, compared to a super premium frozen pizza, “Brand X”, in a blind study revealed:

TABLE 1

| | | Super-premium |
|---|---|---|
| | Claimed frozen pizza | frozen |
| | in bakeable tray | pizza “Brand X” |
| Hedonic Ratings | | |
| (Mean on 9-pt. Scale) | | |
| Appearance of Crust | 6.3 | 6.5 |
| Overall Taste of Crust | 6.9 | 5.8 |
| Texture of Crust | 7.1 | 6.1 |
| Directional Ratings | | |
| (% Just About Right) | | |
| Ratio of Crust to Toppings | 69 | 62 |
| Overall Amount | 75 | 58 |
| Amount at Outer Edge | 64 | 60 |
| Garlic Flavor in Crust | 49 | 40 |
| Texture | 81 | 58 |
| Crispiness/Doughiness | 74 | 52 |
| Thickness/Thinness | 71 | 60 |
| Lightness/Airiness | 79 | 62 |

Blind (N = 85)

So, as can be seen from the above Table 1, the claimed frozen pizza and bakeable disposable single-use tray outperformed the comparative super premium frozen pizza Brand X for crust evaluation in every category except for “appearance of crust.”

Test results for the crust evaluation of the claimed frozen pizza with dough of the recipe provided above and bakeable single-use disposable tray (in this instance, paperboard) combination compared to a store made, delivered pizza, “Brand Y”, in a blind study revealed:

TABLE 2

| | Claimed frozen pizza | Delivered pizza |
|---|---|---|
| | in bakeable tray | brand Y |
| Hedonic Ratings | | |
| (Mean on 9-pt. Scale) | | |
| Appearance of Crust | 6.3 | 6.7 |
| Overall Taste of Crust | 6.9 | 6.0 |
| Texture of Crust | 7.0 | 5.9 |
| Directional Ratings | | |
| (% Just About Right) | | |
| Ratio of Crust to Toppings | 77 | 62 |
| Overall Amount | 66 | 62 |
| Amount at Outer Edge | 66 | 56 |
| Garlic Flavor in Crust | 71 | 47 |
| Texture | 83 | 52 |
| Crispiness/Doughiness | 68 | 42 |
| Thickness/Thinness | 71 | 69 |
| Lightness/Airiness | 71 | 68 |

Blind (N = 77)

So, as can be seen from the above Table 2, the claimed frozen pizza and bakeable disposable single-use tray outperformed the comparative delivered pizza Brand Y in every category for crust evaluation except for “appearance of crust.”

The above specification, examples and data provide description of principles of this disclosure. Many embodiments can be made.

We claim:

1-20. (canceled)

21. A frozen pizza and tray combination comprising:
(a) a bakeable single-use disposable tray including a holding surface;
(i) the holding surface having a cooking side that is substantially flat;
(ii) the holding surface having an opposite oven-engaging side;
(iii) a perimeter side panel extending vertically from the holding surface;
(A) the perimeter side panel extending 0.25-1.0 inch from the holding surface; and
(b) a frozen pizza including a crust and toppings on the crust;
(i) the crust having a bottom surface positioned on and against the substantially flat cooking side of the holding surface of the bakeable tray;
(ii) the frozen pizza including a cut arrangement including a cut line having segments of cut portions that extend completely through the crust along the cut line; each segment being separated by an uncut portion of the crust along the cut line; and
(iii) the crust being formed of a dough comprising about 55-65% flour, 25-30% water, 3-8% yeast, and 1-4% shortening.

22. A frozen pizza and tray combination according to claim 21 wherein the bakeable single-use disposable tray comprises at least one of: paperboard, crystalline polyethylene terephthalate (CPET), aluminum, and corrugate.

23. A frozen pizza and tray combination according to claim 21 wherein the bakeable single-use disposable tray cooking side comprises polybutylene terephthalate (PBT) polyester.

24. A frozen pizza and tray combination according to claim 21 wherein the crust is formed of a dough comprising about 59-60% flour, 28-29% water, 5-6% yeast, and 2-3% shortening.

25. A frozen pizza and tray combination according to claim 21 wherein the perimeter side panel extends 0.25-0.75 inch from the holding surface.

26. A frozen pizza and tray combination according to claim 21 wherein the bakeable single-use disposable tray is circular having a diameter of 5-18 inches.

27. A frozen pizza and tray combination according to claim 21 wherein the perimeter side panel is angled away from the cooking surface at about 17-19 degrees off of a vertical line.

28. A frozen pizza and tray combination according to claim 21 wherein the bakeable single-use disposable tray has a depth measured from a top of the side panel to a top of the substantially flat cooking side of about 0.4-0.6 inch.

29. A frozen pizza and tray combination according to claim 21 wherein the cut arrangement includes at least one cut line extending through the thickness of the crust and dividing the frozen pizza into individual serving pieces; the at least one cut line having uncut portions along the cut line such that no individual serving piece is disconnected from a remaining portion of the pizza.

30. A frozen pizza and tray combination according to claim 29 wherein each of the uncut portions has a length of ⅛^{th}-¾^{th} inch.

31. A method of making a combination frozen pizza and bakeable tray; the method comprising:
(a) providing an uncooked and unfrozen pizza including a crust with toppings;
(i) the crust being formed of a dough comprising about 55-65% flour, 25-30% water, 3-8% yeast, and 1-4% shortening;
(b) slicing the pizza with at least one cut line having segments of cut portions that extend completely through the crust, each segment being separated by an uncut portion of the crust along the cut line to create individual serving pieces such that no individual serving piece is disconnected from a remaining portion of the pizza;
(c) placing the sliced pizza into a bakeable single-use disposable tray such that a bottom of the crust is oriented against a holding surface having a cooking surface on the bakeable single-use disposable tray to form a sliced pizza and tray arrangement;
(i) the cooking surface being substantially flat and against the bottom of the crust;
(ii) a perimeter side panel extending vertically 0.25-1.0 inch from the holding surface; and
(d) freezing the sliced pizza and tray arrangement.

32. A method according to claim 31 wherein the step of providing a crust includes forming the crust of a dough comprising about 59-60% flour, 28-29% water, 5-6% yeast, and 2-3% shortening.

33. A method according to claim 31 wherein the step of placing the sliced pizza into a bakeable single-use disposable tray includes placing the sliced pizza into a tray having a depth from the cooking surface to a top of the perimeter side panel of about 0.4-0.6 inch.

34. A method according to claim 31 wherein:
(a) the step of providing an uncooked and unfrozen pizza includes providing a circular pizza; and
(b) the step of slicing includes slicing the pizza into at least 2 sectors and leaving uncut portions along the cut lines; each uncut portion having a length no greater than 1 inch.

35. A method of making a pizza; the method comprising:
(a) providing a frozen pizza and tray combination including a bakeable single-use disposable tray including a holding surface with a substantially flat cooking side and an opposite oven-engaging side; a frozen pizza including a crust and toppings on the crust;
(i) the crust having a bottom surface positioned on and against the substantially flat cooking side of the holding surface of the bakeable tray;
(ii) a perimeter side panel extending vertically from the holding surface; the perimeter side panel extending 0.25-1.0 inch from the holding surface;
(iii) the frozen pizza including a cut arrangement including a cut line having segments of cut portions that extend completely through the crust along the cut line, each segment being separated by an uncut portion of the crust along the cut line;
(b) putting the frozen pizza and tray combination into an oven;
(c) baking the frozen pizza and tray combination to result in a cooked pizza on the tray;
(d) removing the tray holding the cooked pizza from the oven;
(e) dividing the cooked pizza into individual serving pieces by manually and without a use of a cutter breaking the uncut portions of the crust; and
(f) disposing of the tray.

36. A method according to claim 35 wherein the step of dividing includes pulling by hand an individual serving piece away from a remaining portion of the pizza and breaking at least one uncut portion having a length of not greater than 1 inch.
